(19) United States
(12) Patent Application Publication
(10) Pub. No.: US 2009/0130304 A1
(43) Pub. Date: May 21, 2009

(54) METHODS OF FORMING COMPOSITE POWDER COATINGS AND ARTICLES THEREOF

(75) Inventors: Tamara Jean Muth, Ballston Lake, NY (US); Vinod Kumar Pareek, Albany, NY (US)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 11/940,880

(22) Filed: Nov. 15, 2007

(51) Int. Cl. B05D 1/12

(52) U.S. Cl. 427/180

(57) ABSTRACT

A method of forming a composite powder coating comprises depositing multiple layers of a powder coating composition onto a substrate, wherein adjacent layers are formed of a different powder coating composition; and curing the multiple layers of the powder coating composition in a single thermal curing step. The layers can be used to protect power generation equipment from aqueous corrosion, particle erosion, slurry erosion, fretting, and foulig.

### BACKGROUND OF THE INVENTION

The present disclosure relates to methods of forming composite powder coatings, and articles thereof.

In power generation systems, multiple layers of powder coatings (i.e., composite coatings) can be used to protect a substrate from aqueous corrosion, particle erosion, slurry erosion, fretting, fouling, and the like. Multiple layers are typically needed to achieve all of the desired properties. To form the multiple layers, each layer is cured before die next coating layer is applied. This can be time-consuming and detrimental to either the substrate or the initial coating layers due to repeated exposure to high curing temperatures, which can result in a loss of beneficial properties to either the substrate or the coating, such as but not limited to, reduced corrosion resistance, poor adhesion, and reduced ductility. In power generation systems, these coatings provide a functional benefit; consequently, layer integrity is important for performance.

Shorter curing times and overall shorter high temperature exposure times are desirable for composite powder coatings used in power generation systems. In view of this objective, a more efficient method of producing composite powder coatings was sought.

### BRIEF DESCRIPTION OF THE INVENTION

Accordingly, embodiments of this disclosure address the need for composite powder coatings that improve manufacturing efficiency and minimize defects caused by exposing the substrate or powder coated layers to high curing temperatures.

In one embodiment, a method of forming a composite powder coating comprises depositing multiple layers of a powder coating composition onto a substrate, wherein adjacent layers are formed of a different powder coating composition, and curing the multiple layers of the powder coating composition in a single thermal curing step. The layers can be used to protect power generation equipment from aqueous corrosion, particle erosion, slurry erosion, fretting, and fouling.

In another embodiment a powder coating can comprise two or more composite powder coatings, each cured in a single thermal curing step, wherein adjacent powder coated layers comprise different compositions. Thus, a method of forming a powder coating on a substrate comprises depositing a first stack comprising multiple layers of a powder coating composition onto the substrate, wherein adjacent layers are formed of a different powder coating composition; curing the first stack in a single thermal curing step; depositing at least one additional stack comprising multiple layers of a powder coating composition onto the first stack, wherein adjacent layers are formed of a different powder coating composition; and curing the at least one additional stack.

Other features and advantages of the disclosed powder coating methods will be or become apparent to one with skill in the art upon examination of the following drawings and detailed description. It is intended that all such additional features and advantages be included within this description, be within the scope of the current disclosure, and he protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIGS. 1(A-B) are schematics illustrating a process of forming a composite powder coating on a substrate.

FIGS. 2(A-D) are schematics illustrating a process of layering two composite powder coatings on a substrate.

The disclosure can be understood more readily by reference to the following detailed description of the various features of the disclosure and the examples included therein.

### DETAILED DESCRIPTION OF THE INVENTION

Disclosed herein are methods of forming composite powder coatings having fewer curing steps than the number of powder coated layers. A composite powder coating herein refers to a multi-layer powder coating comprising at least two powder coated layers that are cured by a single thermal curing step, and wherein adjacent layers comprise different powder coating compositions. Also disclosed are articles comprising composite powder coatings produced by the disclosed methods, and in particular articles for power generation systems comprising a metal substrate such as blades on a rotor for turbine engines.

Advantageously, the disclosed coating methods minimize the number of curing steps while still protecting articles from aqueous corrosion, particle erosion, slurry erosion, fretting, fouling, and the like. By curing multiple powder coated layers in a single curing step, production efficiency improves. In addition, the substrate and the first coating layers experience shorter overall exposure times to potentially damaging high cure temperatures.

Suitable substrates can comprise any shape, including flat sheets of material, material having rough surfaces or non-planar surfaces, wires, and material with perforations. Powder coating compositions are deposited to all or selected surfaces of the substrate that include edges or the inside surface of a perforation. Substrates can comprise any material compatible with the curing conditions. Although metal substrates for power generation systems are particularly contemplated, the methods disclosed herein are also useful in applying powder coatings to other substrates including non-metallic substrates; for example glass, ceramic, plastic, wood, paper, cardboard, corrugated stock, cloth, and plastic film.

Metal substrates include magnetic and non-magnetic metal substrates. Exemplary metal substrates include aluminum and aluminum alloys, copper and copper alloys, magnesium arid magnesium alloys, nickel and nickel alloys, iron, and iron alloys such as various steel alloys, tin and tin alloys, titanium and titanium alloys, tungsten and tungsten alloys, zinc and zinc alloys, and combinations comprising at least one of the foregoing metal substrates.

Metal substrates can be first grit blasted with various medias, for example, Alumina grit, to roughen the surface and promote adhesion of the powder layers. The air supply used for the grit blasting is free from contaminants such as water, oil, or the like, and can be preheated.

The method of forming the composite powder coating herein can further comprise depositing an adhesive layer or primer layer between the substrate and the first powder coating layer to promote adhesion of the first powder coating layer to the substrate. The adhesive layer is not counted as a powder coating layer herein if it requires a separate curing step, or if it is applied as a liquid.

The optional adhesive layer can comprise a resin in an uncured condition or other liquid or semi-liquid material. However, more suitable materials contemplated for the adhesive layer include epoxy resins and phenol resins in the uncured state, and various monomers. Desirable adhesive layers harden with heating, but they can also be materials that do not necessarily harden with heating. When a selected surface of the substrate has been covered with a resin layer, the resin in the surface layer can be treated with a solvent so as to form an adhesive layer.

The multiple powder coated layers are deposited sequentially by any powder coating method known in the art. These include fluidized bed, electrostatic fluidized bed, flocking, molding, magnetic brush, cloud chamber, electrostatic spray (both with corona-charged and tribe-charged guns), and flame spray (high velocity oxygen fuel (HVOF), thermal spray, and the like), among others.

The layers of a composite powder coating can be deposited at any temperature, but more typically at ambient temperature. Adjustments to voltage, fluidizing air flow, or atomizing air flow vary with the powder coating composition and the deposition method. A powder coated layer has a thickness of about 10 to about 250 micrometers (0.4 to 10 mil) and more particularly from about 70 to about 130 micrometers (3 to 5 mil) before curing. Adjacent layers in the composite powder coating comprise different compositions. For substrates used in power generation, the compositions are selected to be effective in inhibiting aqueous corrosion, particle erosion, slurry erosion, fretting, and fouling known to be problematic for blades on a rotor in turbine engines.

At least two powder coated layers are deposited before a curing step. The powder coated layers can be cured at a particular temperature and for a defined time, or follow a “curing profile” in which the cure conditions such as temperature, time, pressure, and the like, are varied during the curing process. The optimum ranges of the curing temperature and time can be determined using methods for known compositions in the art or can be determined by screening a modest number of different curing conditions.

Powder coating compositions are created by blending various components that can include binders, resins, pigments, fillers, and other additives, for example, and processing the components by heating and milling, for example, and extruding the blended mass. The mass is then cooled, crushed into small chips or lumps, and then ground into a powder, which can then be deposited on the substrate to produce a coated substrate. An exemplary disclosure of powder particles, their composition and manufacture, which can be used in accordance with the disclosed methods, is provided in the Complete Guide to Powder Coatings (Issue 1-November 1999) of Akzo Nobel.

The powder particles have a particle size ranging from about 5 to 150 micrometers, more particularly about 5 to about 100 micrometers and, even more particularly, about 5 to about 75 micrometers, thereby resulting in coated layers that have fewer, or substantially fewer defects such as pinholes, after curing. Powder coated layers are commonly 25 to 100 micrometers (approximately 1-4 mil) in thickness for suitable substrate protection. Thicker layers are coated for larger particulates to ensure that a minimum coverage is realized. Smaller particle sizes (less than 50 micrometers) are more desirable for generating uniform coatings.

The powder coating compositions include a film-forming resin, more specifically curable thermoplastic and thermosetting polymers. As used herein, “film-forming” refers to resins that can form a continuous film on a surface upon removal of any solvents or carriers present in the composition or upon curing at ambient or elevated temperature.

Exemplary film-forming resins include, for example, those formed from the reaction of a polymer having at least one type of reactive functional group and a curing agent having functional groups reactive with the functional group(s) of the polymer. As used herein, the term “polymer” is meant to encompass oligomers, and includes without limitation both homopolymers and copolymers. The polymers can be, for example, acrylic, polyester, polyurethane, polyether, polyvinyl, cellulosic, acrylate, silicon-based polymers, co-polymers thereof, and mixtures thereof, and can contain functional groups such as epoxy, carboxylic acid, hydroxyl, isocyanate, amide, carbamate and carboxylate groups.

Acrylic polymers include copolymers of acrylic acid or methacrylic acid, or hydroxyalkyl esters of acrylic or methacrylic acid such as hydroxyethyl methacrylate or hydroxypropyl acrylate with one or more other polymerizable ethylenically unsaturated monomers such as alkyl esters of acrylic acid including methyl methacrylate and 2-ethyl hexyl acrylate, and vinyl aromatic compounds such as styrene, alpha-methyl styrene and vinyl toluene. The ratio of reactants and reaction conditions are selected to result in an acrylic polymer with pendant hydroxyl or carboxylic acid functionality.

The powder coating compositions can also comprise a polyester polymer or oligomer, including those containing free terminal hydroxyl and/or carboxyl groups. Such polymers are prepared in a known manner by condensation of polyhydric alcohols and polycarboxylic acids. Suitable polyhydric alcohols include ethylene glycol, neopentyl glycol, trimethylol propane and pentaerythritol.

Exemplary polycarboxylic acids include adipic acid, 1,4-cyclohexyl dicarboxylic acid and hexahydrophthalic acid. Besides the polycarboxylic acids mentioned above, functional equivalents of the acids such as anhydrides or lower alkyl esters of the acids such as the methyl esters can he used. Also, small amounts of monocarboxylic acids such as stearic acid can be used.

Hydroxyl-containing polyester oligomers can be prepared by reacting an anhydride of a dicarboxylic acid such as hexahydrophthalic anhydride with a diol such as neopentyl glycol in a 1:2 molar ratio.

Where it is desired to enhance air-drying, suitable drying oil fatty acids can be used and include those derived from linseed oil, soya bean oil, tall oil, dehydrated castor oil or lung oil.

The powder coating compositions can also comprise polyurethane polymers containing terminal isocyanate (NCO-terminated) or terminal hydroxyl (OH-terminated) groups. The NCO-terminated or OH-terminated polyurethanes include those prepared by reacting polyols including polymeric polyols with polyisocyanates. The powder coating compositions can further comprise polyureas containing terminal isocyanate or primary or secondary amine groups prepared by reacting polyamines including polymeric polyamines with polyisocyanates. The hydroxyl/isocyanate or amine/isocyanate equivalent ratio is adjusted and reaction conditions selected to obtain the desired terminal group.

The powder coating compositions can also comprise a silicon-based polymer. As used herein, by “silicon-based polymers” is meant a polymer comprising one or more —SiO— units in the backbone. Such silicon-based polymers can include hybrid polymers, such as those comprising organic polymeric blocks with one or more —SiO— units in the backbone.

The powder coating compositions can also comprise curing agents including polyisocyanates, blocked isocyanates, anhydrides, epoxides, polyepoxides, polyacids, polyols, polyamines, amine resins, phenols, and combinations thereof. The powder coating compositions can be formulated as a one-component composition where a curing agent is admixed with other components. The one-component composition can be storage stable as formulated. Alternatively, such powder coating compositions can be formulated as a two-component composition where, for example, a polyisocyanate curing agent such as those described above can be added to a pre-formed admixture of the other composition components just prior to application. The pre-formed admixture can comprise curing agents for example, amino resins and/or blocked isocyanate compounds such as those described above. Curing typically comprises heating the composite powder coating at a temperature of about 20° C. to about 370° C. (about 68° F. to about 700° F.) for about 5 to about 60 minutes, and more specifically about 182° C. to about 227° C. (about 360° F. to about 440° F.) for about 20 to about 40 minutes. Typically, two or three layers are sufficient to protect a substrate.

In one embodiment, the film-forming resin is generally present in the powder coating composition in an amount greater than about 30 weight percent, more particularly greater than about 40 weight percent and less than 90 weight percent, with weight percent being based on the total weight of the powder coating composition. For example, the weight percent of resin can be between 30 and 90 weight percent of the powder coating composition. When a curing agent is used, it is generally present in an amount of up to 70 weight percent, typically between 10 and 70 weight percent based on the total weight of the powder coating composition.

The powder coating compositions can also comprise optional additives such as those well known in the art of formulating surface coatings. Such optional additives can comprise, for example, surface active agents, flow control agents, thixotropic agents, fillers, anti-gassing agents, organic co-solvents, catalysts, antioxidants, light stabilizers, pigments, UV absorbers and combinations thereof. Optional ingredients can be present in amounts as low as 0.01 weight percent and as high as 20.0 weight percent based on total weight of the powder coating composition. Usually the total amount of optional ingredients will range from 0.01 to 25 weight percent, based on total weight of the powder coating composition.

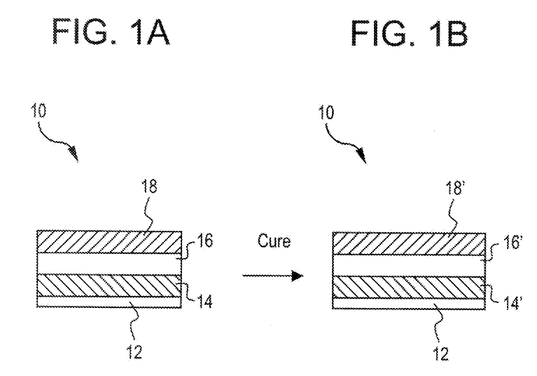

Thus, in one embodiment, a method of forming a composite powder coating comprises depositing multiple layers of a powder coating composition onto a substrate, wherein adjacent layers are formed of a different powder coating composition, and curing the multiple layers of the powder coating composition in a single thermal curing step. FIG. 1A illustrates an article generally designated 10, having substrate 12 and multiple powder coated layers 14, 16, and 18 coated thereon. Layers 14, 16, and 18 are sequentially deposited on substrate 12 and then submitted to a single thermal curing step to form cured layers 14′, 16′ and 18′ corresponding to uncured layers 14, 16, and 18, respectively, as shown in FIG. 1B. Adjacent powder coated layers have different compositions. Thus, powder coated layers 18 and 16 have different compositions; powder coated layers 16 and 14 have different compositions. Powder coated layers 18 and 14 can have the same or different compositions. More or fewer powder coated layers can be deposited and cured in this manner.

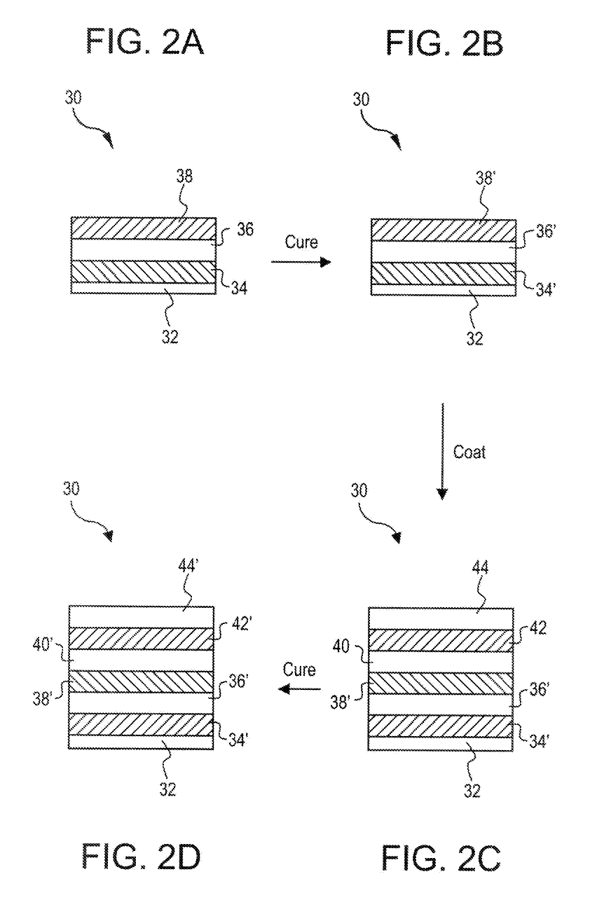

In another embodiment a powder coating can comprise two or more composite powder coatings, each cured in a single thermal curing step, wherein adjacent powder coated layers comprise different compositions. Thus, a method of forming a powder coating on a substrate comprises depositing a first stack comprising multiple layers of a powder coating composition onto the substrate, wherein adjacent layers are formed of a different powder coating composition; curing the first stack in a single thermal curing step; depositing at least one additional stack comprising multiple layers of a powder coating composition onto the first stack, wherein adjacent layers are formed of a different powder coating composition; and curing the at least one additional stack. This process is illustrated in FIGS. 2A to 2D. In FIG. 2A, an article 30 includes a substrate 32 having uncured powder coated layers 34, 36, and 38 deposited thereon. These layers are then thermally cured to form cured layers 34′, 36′ and 38′ as shown in FIG. 2B. Three additional uncured powder coated layers, 40, 42, and 44 are then deposited on the topmost cured layer 38′ as shown in FIG. 2C. Uncured layers 40, 42 and 44 are then thermally cured to form cured layers 40′, 42′ and 44′ as shown in FIG. 2D, wherein adjacent layers are formed of different powder coating compositions.

In another embodiment, a coated article comprises a composite powder coating formed by the methods disclosed herein. The article can be a blade on a rotor for a turbine engine, a bucket for a turbine engine, water treatment equipment, enclosures for electrical and telecommunication devices, light fixtures; lighting appliances; network interface device housings; transformer housings, coated painted articles, and other articles used in automotive, aircraft, construction, housing, computer, and electronics industries.

The described methods of preparing composite powder coatings advantageously avoid exposing the substrate and the individual coating layers to prolonged high temperatures as in typical multiple curing cycles. Product integrity is therefore improved. The methods also improve manufacturing efficiency and shorten manufacturing cycle time, thus lowering cost.

The terms “a” and “an” do not denote a limitation of quantity, but rather denote the presence of at least one of the referenced item. The endpoints of all ranges directed to the same characteristic or component are independently combinable and inclusive of the recited endpoint. All amounts, parts, ratios and percentages used herein are by weight unless otherwise specified. Like reference characters designate like or corresponding parts throughout the several views shown in the figures. It is also understood that terms such as “top”, “bottom”, “outward”, “inward”, and the like are words of convenience and are not to be construed as limiting terms. It is to be noted that the terms “first,” “second,” and the like as used herein do not denote any order, quantity, or importance, but rather are used to distinguish one element from another. The modifier “about” used in connection, with a quantity is inclusive of the stated value and has the meaning dictated by the context (e.g., includes the degree of error associated with measurement of the particular quantity).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of forming a composite powder coating, comprising:
depositing multiple layers of a powder coating composition onto a substrate, wherein adjacent layers are formed of a different powder coating composition; and
curing the multiple layers of the powder coating composition in a single thermal curing step.

2. The method of claim 1 wherein the substrate is selected from the group of metals consisting of aluminum, aluminum alloys, copper, copper alloys, magnesium magnesium alloys, nickel, nickel alloys, iron, iron alloys, steel alloys, tin, tin alloys, titanium, titanium alloys, tungsten, tungsten alloys, zinc, zinc alloys, and combinations comprising at least one of the foregoing metal substrates.

3. The method of claim 1, wherein the substrate further comprises an adhesive layer or primer layer to promote adhesion of the composite powder coating to the substrate.

4. The method of claim 3, wherein the adhesive layer comprises an epoxy resin or a phenol resin.

5. The method of claim 1, wherein depositing the multiple layers of the powder coating composition comprises a fluidized bed process, an electrostatic fluidized bed process, a flocking process, a molding process, a magnetic brush process, a cloud chamber process, an electrostatic spray process, a flame spray process, or combinations thereof.

6. The method of claim 1, wherein each layer has a thickness of about 10 to about 250 micrometers before curing.

7. The method of claim 1, wherein each layer has a thickness of about 70 to about 130 micrometers before curing.

8. The method of claim 1, wherein the powder coating composition comprises particles having a median particle size of about 5 to about 150 micrometers.

9. The method of claim 1, wherein the powder coating composition comprises particles having a median particle size of about 5 to about 100 micrometers.

10. The method of claim 1, wherein the powder coating composition comprises particles having a median particle size of about 5 to about 75 micrometers.

11. The method of claim 1, wherein the powder coating composition comprises a thermoplastic resin.

12. The method of claim 1, wherein the powder coating composition comprises a thermosetting resin.

13. The method of claim 1, wherein the powder coating composition comprises a polymer selected from the group consisting of an acrylic, polyester, polyurethane, polyether, polyvinyl, cellulosic, acrylate, silicon-based polymers, co-polymers thereof, and combinations thereof.

14. The method of claim 1, wherein the powder coating composition comprises an additive selected from the group consisting of surface active agents, flow control agents, thixotropic agents, fillers, anti-gassing agents, organic co-solvents, catalysts, antioxidants, light stabilizers, pigments, UV absorbers and combinations comprising at least one of the foregoing additives.

15. The method of claim 1, wherein curing comprises heating the multiple layers of the powder coating composition at a temperature of about 20° C. to about 370° C. for about 5 to about 60 minutes.

16. The method of claim 1, wherein curing comprises heating the multiple layers of the powder coating at a temperature of about 182° C. to about 227° C. for about 20 to about 40 minutes.

17. The method of claim 1 wherein the substrate is a blade on a rotor for a turbine engine.

18. A method of forming a powder coating on a substrate, comprising:
depositing a first stack comprising multiple layers of a powder coating composition onto the substrate, wherein adjacent layers are formed of a different powder coating composition;
curing the first stock in a single thermal curing step;
depositing at least one additional stack comprising multiple layers of a powder coating composition onto the first stack, wherein adjacent layers are formed of a different powder coating composition; and
curing the at least one additional stack.
